(19) United States
(12) Patent Application Publication
(10) Pub. No.: US 2009/0019464 A1
(43) Pub. Date: Jan. 15, 2009

(54) Disk apparatus

(75) Inventors: Yorio Takahashi, Ehime (JP); Motohiro Kawakami, Ehime (JP)

Correspondence Address: KRATZ, QUINTOS & HANSON, LLP, 1420 K Street, N.W., Suite 400, WASHINGTON, DC, 20005, US

(73) Assignee: Matsushita Electric Industrial Co., Ltd, Kadoma-shi (JP)

(21) Appl. No.: 10/585,301

(22) PCT Filed: Sep. 1, 2005
(86) PCT No.: PCT/JP2005/016019

§ 371 Date: Jul. 6, 2006

(30) Foreign Application Priority Data
Sep. 10, 2004 (JP) 2004-263184

(51) Int. Cl. G11B 17/04

(52) U.S. Cl. 720/624

(57) ABSTRACT

It is an object of the present invention to provide a disk apparatus capable of securing an effective area of a printed board by setting a moving range of a disk-detecting operation pin to a position where the printed board is not hindered.

A chassis outer sheath comprises a base body 10 and a lid. The base body 10 is provided at its rear surface with a lever 110 which is moved by inserting a disk, a rear base 13 is provided at a location which is not superposed with the traverse 30 and at a location covering the printed board 14, an operation pin 114 is provided on a lower surface of the lever, a disk insertion detecting switch 115 is disposed in the vicinity of a rear portion on the printed board 14, the moving range of the operation pin 114 is located closer to the rear surface than a turning fulcrum 111 of the lever 100.

### TECHNICAL FIELD

The present invention relates to a disk apparatus for recording or replaying into or from a disk-like recording medium such as a CD and a DVD, and more particularly, to a so-called slot-in type disk apparatus capable of directly inserting or discharging a disk from or to outside.

### BACKGROUND TECHNIQUE

A loading method is widely employed in conventional disk apparatuses. In this method, a disk is placed on a tray or a turntable, and the tray or the turntable is loaded into an apparatus body.

According to such a loading method, however, since the tray or the turntable is required, there is a limit for thinning the disk apparatus body.

As a slot-in type disk apparatus, there is proposed a method in which a conveying roller is abutted against a disk surface to pull the disk in (e.g., a patent document 1).

As a slot-in type disk apparatus capable of reducing its thickness and size, there exists an apparatus in which a traverse is disposed on the side of a disk inserting opening, a printed board is disposed on the side of a connector, a spindle motor is located at a central portion of a base body, a reciprocating range of a pickup is located closer to the disk inserting opening than the spindle motor, the traverse is disposed and operated such that a reciprocating direction of the pickup is different from an inserting direction of the disk, and a spindle motor is disposed close to the base body or a lid.

(Patent document 1) Japanese Patent Application Laid-open No. H7-220353

(Patent document 2) Japanese Patent Application Laid-open No. 2002-352498

### DISCLOSURE OF THE INVENTION

### Problem to be Solved by the Invention

According to the slot-in type as proposed in the patent document 1, however, since a conveying roller which is longer than a diameter of the disk is used, the width of the apparatus must be increased, and the thickness of the apparatus is also increased due to this conveying roller.

Therefore, in the slot-in type disk apparatus, it is difficult to reduce a main body of the disk apparatus in thickness and size.

In the case of the apparatus of the patent document 2, it is possible to reduce its thickness and size, but in order to further reduce the thickness and size, it is necessary to reduce the printed board in size.

Hence, it is an object of the present invention to provide a disk apparatus capable of securing an effective area of the printed board by allowing a disk-detecting operation pin to move in a position where the printed board is not hindered.

### Means for Solving Problem

A first aspect of the present invention provides a disk apparatus comprising a chassis outer sheath having a base body and a lid, in which a front surface of the chassis outer sheath is formed with a disk inserting opening into which a disk is directly inserted, a connector is disposed on a rear surface of the chassis outer sheath, a traverse is disposed on a side of the disk inserting opening, a printed board is disposed on a side of the connector, the traverse holds a spindle motor, a pickup and drive means which drives the pickup, the spindle motor is disposed on a central portion of the base body, a lever which is moved by inserting a disk is provided on the side of the rear surface of the base body, a rear base is provided at a location which is not superposed with the traverse and at a location covering the printed board, an operation pin is provided on a lower surface of the lever, a disk insertion detecting switch is disposed in the vicinity of a rear portion on the printed board, wherein the moving range of the operation pin is located closer to the rear surface than a turning fulcrum of the lever.

According to a second aspect of the invention, in the invention of the first aspect, the moving range of the operation pin is a rear surface side end of the printed board.

According to a third aspect of the invention, in the invention of the first aspect, the operation pin is disposed such that the moving range of the operation pin is substantially in parallel to the rear surface.

According to a fourth aspect of the invention, in the invention of the second or third aspect, a motion hole of the operation pin is provided in a moving range of the operation pin on the printed board or a range wider than the moving range.

According to a fifth aspect of the invention, in the invention of the first aspect, the disk insertion detecting switch is provided such that a switch lever is disposed close to the rear surface.

### EFFECT OF THE INVENTION

According to the present invention, it is possible to secure the effective area of the printed board, and to reduce the main body of the apparatus in thickness and size.

### BRIEF DESCRIPTION OF THE DRAWINGS

FIG. 1 is a plan view of an essential portion of a disk apparatus according to an embodiment;

FIG. 2 is an enlarged plan view of an essential portion of the disk apparatus showing a state where a disk is not inserted;

FIG. 3 is an enlarged plan view of an essential portion of the disk apparatus showing a state where insertion of a disk is detected;

FIG. 4 is an enlarged plan view of an essential portion of the disk apparatus according to another embodiment showing a state where a disk is not inserted; and

FIG. 5 is an enlarged plan view of an essential portion of the disk apparatus showing a state where insertion of a disk is detected.

### EXPLANATION OF SYMBOLS

| | |
|---|---|
| 10 | base body |
| 11 | disk inserting opening |
| 114 | operation pin |
| 115 | disk insertion detecting switch |
| 116 | switch lever |

### BEST MODE FOR CARRYING OUT THE INVENTION

In the disk apparatus of the first aspect of the present invention, the moving range of the operation pin is located closer to the rear surface than a turning fulcrum of the lever. According to this aspect, the printed board can be disposed close to the rear surface.

According to the second aspect of the invention, in the disk apparatus of the invention of the first aspect, the moving range of the operation pin is a rear surface side end of the printed board. According to this aspect, the printed board can be disposed close to the rear surface.

According to the third aspect of the invention, in the disk apparatus of the invention of the first aspect, the operation pin is disposed such that the moving range of the operation pin is substantially in parallel to the rear surface. According to this aspect, the printed board can be disposed close to the rear surface.

According to the fourth aspect of the invention, in the disk apparatus of the invention of the second or third aspect, a motion hole of the operation pin is provided in a moving range of the operation pin on the printed board or a range wider than the moving range. According to this aspect, the motion hole formed in the printed board is directed in the longitudinal direction of the printed board, constraints of wiring on the printed board can be reduced.

According to the fifth aspect of the invention, in the disk apparatus of the invention of the first aspect, the disk insertion detecting switch is provided such that a switch lever is disposed close to the rear surface. According to this aspect, since the switch lever is disposed close to the rear surface, the printed board can be disposed close to the rear surface.

### PREFERRED EMBODIMENT

A disk apparatus of an embodiment of the present invention will be explained below.

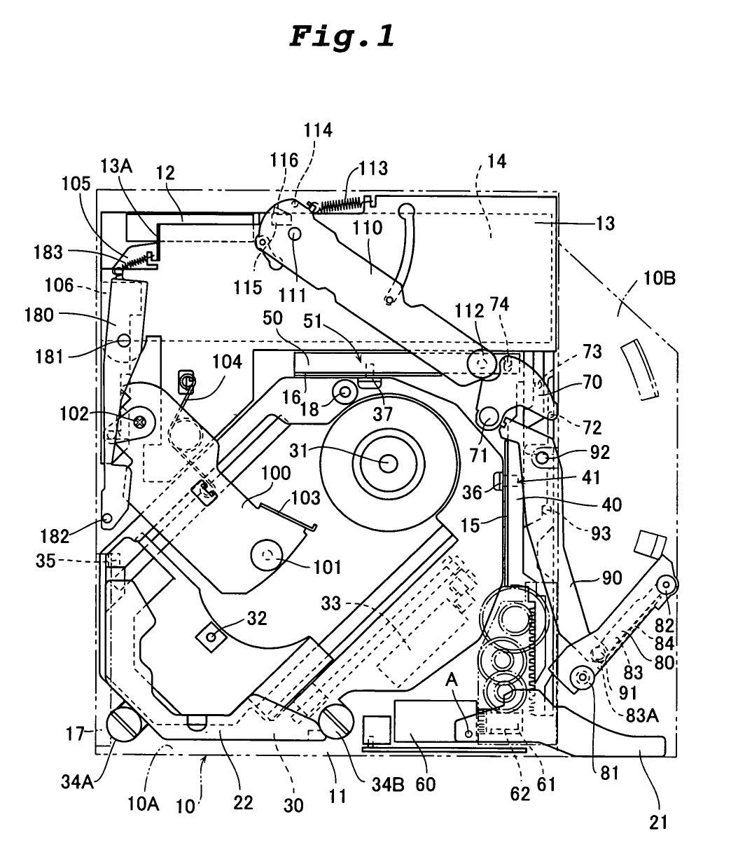

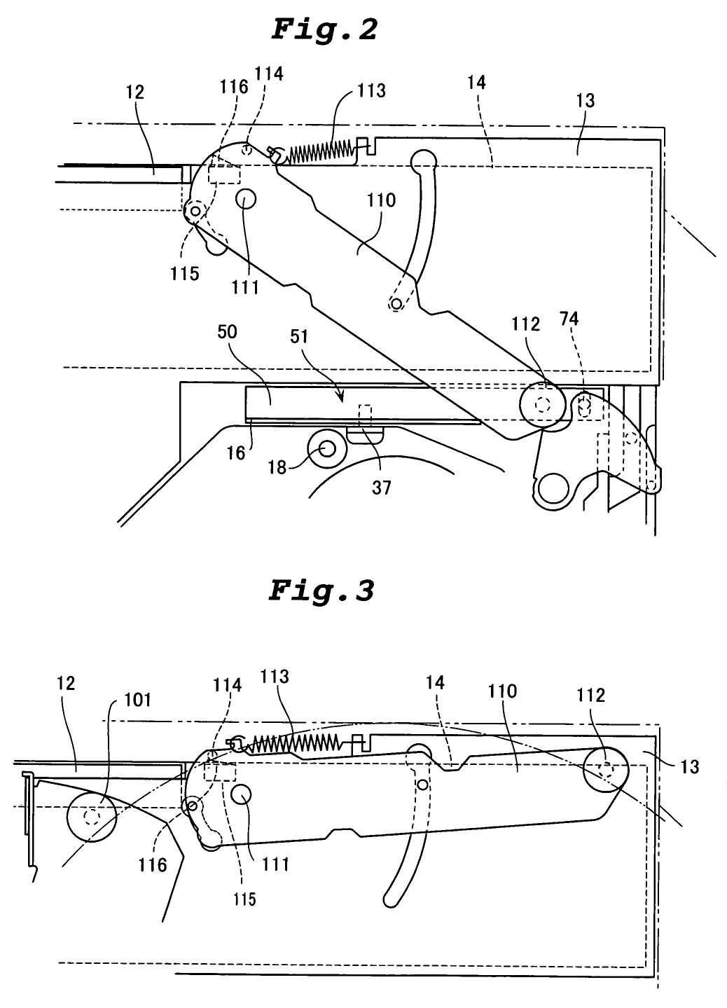

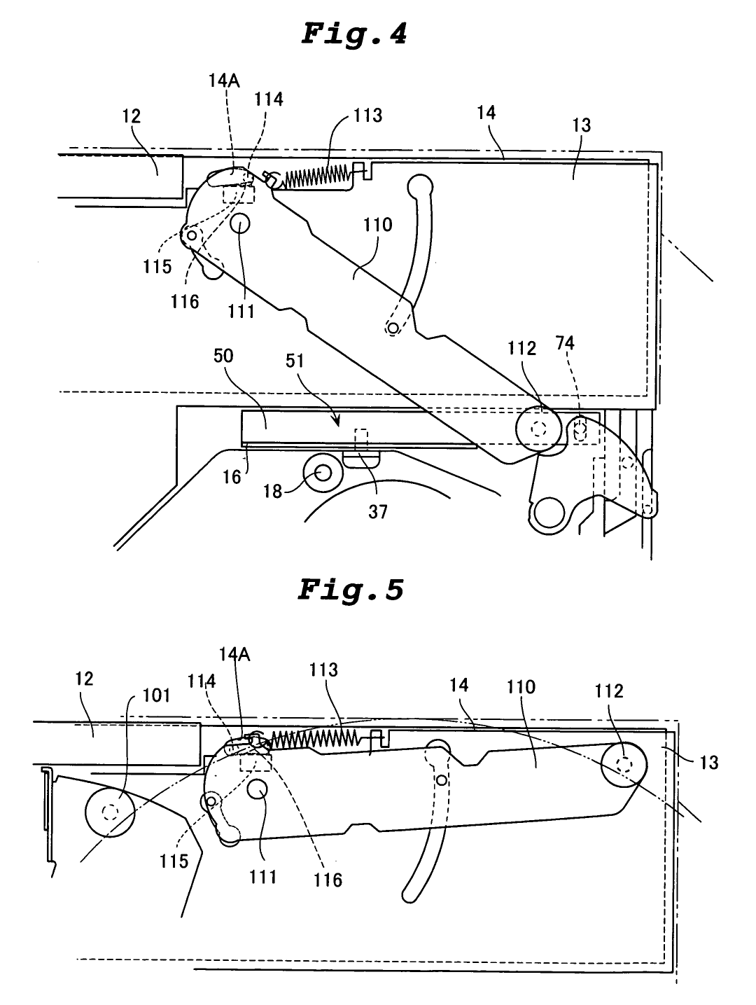

FIG. 1 is a plan view of an essential portion of a disk apparatus according to an embodiment, FIG. 2 is an enlarged plan view of an essential portion of the disk apparatus showing a state where a disk is not inserted, FIG. 3 is an enlarged plan view of an essential portion of the disk apparatus showing a state where insertion of a disk is detected, FIG. 4 is an enlarged plan view of an essential portion of the disk apparatus according to another embodiment showing a state where a disk is not inserted, and FIG. 5 is an enlarged plan view of an essential portion of the disk apparatus showing a state where insertion of a disk is detected.

The disk apparatus of this embodiment includes a chassis outer sheath comprising a base body and a lid. A bezel is mounted on a front surface of the chassis outer sheath. The disk apparatus of this embodiment is a slot-in type disk apparatus in which a disk is directly inserted from a disk inserting opening formed in the bezel shown in FIG. 3.

As shown in FIG. 1, various parts which perform recording/replaying function to and from a disk and a loading function of the disk are mounted on a base body 10.

The base body 10 is formed with a deep bottom 210 and a shallow bottom 310. A wing portion extending from a front surface to a rear surface is formed by the shallow bottom 310.

The base body 10 is formed at its front side with a disk inserting opening 11 into which a disk is directly inserted, and a connector 12 is disposed on an end of a rear surface of the base body 10. A traverse 30 is disposed on the base body 10 on the side of the disk inserting opening 11, and a rear base 13 is disposed on the base body 10 on the side of the connector 12. The traverse 30 and the rear base 13 are disposed such that they are not superposed on each other. A printed board 14 is provided on the rear base 13 on the side of a surface of the base body 10.

The traverse 30 holds a spindle motor 31, a pickup 32 and drive means 33 which moves the pickup 32. The spindle motor 31 is provided on one end of the traverse 30, and the pickup 32 is movably provided from one end to the other end of the traverse 30. When the pickup 32 is stopped, it is disposed on the other end side of the traverse 30. The drive means 33 includes a drive motor, a pair of rails on which the pickup 32 slides, and a gear mechanism for transmitting rotation of the drive motor to the pickup 32. The pair of rails are disposed on both sides such as to connect one end and the other end of the traverse 30. The drive motor is disposed such that a drive shaft is in parallel to the rails on the outer side of the rail on the side of disk inserting opening 11. The gear mechanism is disposed in a space between the drive motor and the rail on the side of the disk inserting opening 11.

In the traverse 30, the spindle motor 31 is located at a central portion of the base body 10, the reciprocating range of the pickup 32 is located closer to the disk inserting opening 11 than the spindle motor 31, and the reciprocating direction of the pickup 32 is different from the inserting direction of the disk. An angle formed between the reciprocating direction of the pickup 32 and the inserting direction of the disk is 40 to 45°.

The traverse 30 is supported on the base body 10 by a pair of insulators 34A and 34B.

It is preferable that the pair of insulators 34A and 34B are disposed closer to a stationary position of the pickup 32 than a position of the spindle motor 31, and closer to the position on the side of the disk inserting opening 11 than the stationary position of the pickup 32. In this embodiment, the insulator 34A is provided on the one end side in the vicinity of an inner side of the disk inserting opening 11, and the insulator 34B is provided on a central portion in the vicinity of the inner side of the disk inserting opening 11. The insulators 34A and 34B includes damper mechanisms made of resilient material. The insulators 34A and 34B can be displaced in a direction where the traverse 30 separates from the base body 10 by the damper mechanism.

A rib 35 is provided on a surface of the traverse 30 on the side of the base body 10. The rib 35 is provided on the side of a stationary position of the pickup 32 outside of the rails opposite from the disk inserting opening 11. The rib 35 has such a sufficient height that the rib 35 abuts against the base body 10 when the traverse 30 is brought close to the base body 10, the traverse 30 can displace in a direction where the traverse 30 separates from the base body 10 at the positions of the insulators 34A and 34B. Although the rib 35 is provided on the surface of the traverse 30 on the side of the base body 10 in this embodiment, the rid 35 may be provided on the surface of base body 10 on the side of the traverse 30. Further, the rib 35 may be provided on both of the surface of the traverse 30 on the side of the base body 10 and the surface of the base body 10 on the side of the traverse 30. Although the traverse 30 on the side of the insulators 34A and 34B rises utilizing the approaching motion of the traverse 30 toward the base body 10 in this embodiment, this can also be realized by another means which changes the height of the traverse 30 at the position of the insulators 34A and 34B, e.g., means which changes the height of the insulators 34A and 34B.

The traverse 30 operates to bring the spindle motor 31 close to and away from the base body 10 around the insulators 34A and 34B as fulcrums.

A main slider 40 and a sub-slider 50 which move the traverse 30 will be explained next.

Cam mechanisms displace the traverse 30. The main slider 40 and the sub-slider 50 are respectively provided with the cam mechanisms. The main slider 40 and the sub-slider 50 are disposed such that they are located on the side of the spindle motor 31. The main slider 40 is disposed such that its one end is located on the side of the front surface of the base body 10 and its other end is located on the rear surface of the base body 10. The sub-slider 50 is disposed in a direction perpendicular to the main slider 40 between the traverse 30 and the rear base 13.

The cam mechanism which displaces the traverse 30 comprises a first cam mechanism 41 and a second cam mechanism 51. The first cam mechanism 41 is provided on a surface of the main slider 40 on the side of the spindle motor 31, and the second cam mechanism 51 is provided on a surface of the sub-slider 50 on the side of the spindle motor 31.

A base member 15 is provided between the main slider 40 and the traverse 30, and a base member 16 is provided between the sub-slider 50 and the traverse 30. The base member 15 and the base member 16 are fixed to the base body 10, limit a position of the cam pin 36 of the traverse 30 by a vertical groove provided in the base member 15, and limit a position of a cam pin 37 of the traverse 30 by a vertical groove provided in the base member 16.

The base member 16 and the sub-slider 50 are connected to each other through a third cam mechanism (not shown in FIG. 1). The third cam mechanism has such a function that when the second cam mechanism 51 moves the traverse 30 away from the base body 10, the third cam mechanism moves the sub-slider 50 away from the base body 10.

A loading motor 60 is disposed on one end of the main slider 40. A drive shaft 61 of the loading motor 60 and one end of the main slider 40 are connected to each other through a gear mechanism. The drive shaft 61 of the loading motor 60 is provided with a worm gear 62 which constitutes the gear mechanism.

The loading motor 60 is disposed such that its main body is located at a central portion of the disk inserting opening 11 and the drive shaft 61 is located on the end of the disk inserting opening 11.

The drive shaft 61 of the loading motor 60 is inclined such that the drive shaft 61 comes close to a disk which is to be inserted into the disk inserting opening 11, and the disk inserting opening 11 of the main body of the loading motor 60 is inclined such as to come close to the disk. That is, the loading motor 60 is provided such that a position “A” shown in FIG. 1 most projects toward the lid. By inclining the loading motor 60 in this manner, even if a disk is inclined when it is to be taken out, an outer peripheral end of the disk is abutted against the position “A” of the main body of the loading motor 60, and it is possible to prevent an inner peripheral surface of the disk from abutting against the main body of the loading motor 60. The same effect can be obtained even if the loading motor 60 is inclined such that the drive shaft 61 thereof is inclined such as to come close to a disk to be inserted into the disk inserting opening 11 or the loading motor 60 is inclined such that the disk inserting opening 11 of the main body thereof is inclined such as to come close to the disk.

By driving the loading motor 60, the main slider 40 can slide in the longitudinal direction. The main slider 40 is connected to the sub-slider 50 through a cam lever 70.

The cam lever 70 includes a turning fulcrum 71, the cam lever 70 is engaged with a cam groove provided in an upper surface of the main slider 40 through a pin 72 and a pin 73, and the cam lever 70 is engaged with a cam groove provided in an upper surface of the sub-slider 50 through a pin 74.

The cam lever 70 has a function that the cam lever 70 moves the sub-slider 50 at timing at which the traverse 30 is displaced by the first cam mechanism 41 of the main slider 40, and the second cam mechanism 51 is moved by the movement of the sub-slider 50, thereby displacing the traverse 30.

The above explained connector 12, traverse 30, rear base 13, printed board 14, insulators 34A and 34B, main slider 40, sub-slider 50, base member 15, base member 16 and loading motor 60 are provided on the deep bottom 210 of the base body 10, and a disk-inserting space is formed between these members and the lid.

Next, a guide member for supporting a disk when the disk is inserted and a lever member which moves when the disk is inserted will be explained.

A first disk guide 17 having a predetermined length is provided on one end of the deep bottom 210 closer to the disk inserting opening 11. The first disk guide 17 has a groove. The groove has a U-shaped cross section as viewed from the disk inserting side. The disk is supported by this groove.

A pulling-in lever 80 is provided in the base body 10 on the other end side of the disk inserting opening 11. The pulling-in lever 80 is provided at its movable side end with a second disk guide 81. The second disk guide 81 comprises a cylindrical roller, and the second disk guide 81 is turnably provided on the movable side end of the pulling-in lever 80. A groove is formed in an outer periphery of the roller of the second disk guide 81, and the disk is supported in this groove.

The pulling-in lever 80 is disposed such that the movable side end is operated closer to the disk inserting opening 11 than the fixed side end, and the fixed side end is provided with a turning fulcrum 82.

A long groove 83 is provided between a movable side end and a fixed side end of a back surface (surface on the side of the base body 10) of the pulling-in lever 80. A third disk guide 84 having a predetermined length is provided between a movable side end and a fixed side end of a front surface of the pulling-in lever 80.

The pulling-in lever 80 is moved by the sub-lever 90.

The sub-lever 90 is provided at its one end on the movable side with a convex portion 91, and at its other end with a turning fulcrum 92. The convex portion 91 of the sub-lever 90 slides in a long groove 83 of the pulling-in lever 80. The turning fulcrum 92 of the sub-lever 90 is located on the main slider 40. The turning fulcrum 92 is not operated in association with the main slider 40, and is fixed to the base body 10 through the base member 15. A pin 93 is provided on a lower surface of the sub-lever 90 closer to the convex portion 91 than the turning fulcrum 92. The pin 93 slides in a cam groove provided in the upper surface of the main slider 40. Therefore, an angle of the sub-lever 90 is changed as the main slider 40 is moved, and the turning angle of the pulling-in lever 80 is changed by changing the angle of the sub-lever 90. That is, the second disk guide 81 of the pulling-in lever 80 is moved toward or away from the spindle motor 31 by the motion of the sub-lever 90. A groove 83A is provided in an end of the long groove 83 closer to the movable side end of the pulling-in lever 80. The groove 83A extends in the turning direction of the sub-lever 90. When the second disk guide 81 pulls the disk most inward by the groove 83A, even if the turning angle of the sub-lever 90 is varied, the turning angle of the pulling-in lever 80 is not varied, and a pulling amount of a disk can be stabilized.

A discharging lever 100 is provided on a side of the base body 10 different from the pulling-in lever 80. A guide 101 is provided on a movable side end of one end of the discharging lever 100. The discharging lever 100 is provided at its other end with a turning fulcrum 102. The discharging lever 100 is provided at its movable side end with an abutting portion 103. The abutting portion 103 is located closer to the rear surface than the guide 101. The discharging lever 100 is provided with a resilient body 104. One end of the resilient body 104 is fixed to the discharging lever 100, and the other end is fixed to the rear base 13. When the abutting portion 103 is pulled toward the rear surface by the resilient body 104, the abutting portion 103 abuts against an abutting portion 13A of the rear base 13. The discharging lever 100 is pulled out toward the disk inserting opening 11 by resilient force of the resilient body 104. The discharging lever 100 is operated in association with motion of the main slider 40 through the link arm 105 and the discharge slider 106. The link arm 105 connects the main slider 40 and the discharge slider 106 with each other, and the discharging lever 100 is engaged with a cam groove of the discharge slider 106 by a cam pin.

A limiting lever 110 is provided on the rear surface of the base body 10. An end of the limiting lever 110 close to the rear surface is a turning fulcrum 111. The limiting lever 110 is provided at its movable side end with a guide 112. The guide 112 of the limiting lever 110 is always biased such as to project toward the front side by a resilient body 113. An opening pin 114 is provided on a lower surface of the limiting lever 110. The operation pin 114 operates a disk insertion detecting switch 115 disposed on a side of a rear surface of the rear base 13.

A guide lever 180 is provided on a side of the base body 10 on the same side as the discharging lever 100. A rear surface of the guide lever 180 is a turning fulcrum 181. The guide lever 180 is provided at its movable side with a guide 182. The guide 182 of the guide lever 180 is biased such as to project toward the disk by a resilient body 183. The guide lever 180 is operated in association with the main slider 40 through the link arm 105 and the discharge slider 106, and the guide 182 separates from the disk in accordance with motion of the main slider 40.

An opening is formed in the traverse 30 in the vicinity of the spindle motor 31. A pin 18 projecting from the base body 10 toward the lid is provided in the opening. In a state where the traverse 30 moves closest to the base body 10, the pin 18 has such a height that the pin 18 projects closer to the lid than the hub of the spindle motor 31. In a driven state of the spindle motor 31 (operating state where replaying and recording can be carried out), the traverse 30 has such a height that the traverse 30 is pulled closer to the base body 10 than the hub of the spindle motor 31. It is preferable that the pin 18 is located at a position corresponding to a non-recording surface of a center portion of a disk mounted on the spindle motor 31, and at a position away from the insulator 34 as compared with the spindle motor 31.

The base body 10 is provided at its front side with a front guider 21 and a traverse felt 22. The front guider 21 is disposed on the side of one end of the disk inserting opening 11 and between the pulling-in lever 80 and the disk inserting opening 11. The front guider 21 is provided such as to cover portions of the loading motor 60, the gear mechanism and the main slider 40. The front guider 21 is provided closer to the lid than these members. The periphery of the front guider 21 is tapered so that the entire recording surface of a disk to be inserted does not come into contact with the front guider 21, and the surface is coated with urethane fluorine. The front guider 21 is fastened to the deep bottom 210 by means of a screw 21A, and is fastened to the shallow bottom 310 by means of a screw 21B. By fastening the front guider 21 to the deep bottom 210 and the shallow bottom 310 by means of the screws 21A and 21B in this manner, it is possible to prevent the shallow bottom 310 from being deformed.

The traverse felt 22 is provided on the other end of the disk inserting opening 11. That is, the traverse felt 22 is provided closer to the lid than the traverse 30 such that the traverse felt 22 covers a portion of the disk inserting opening 11 of the traverse 30. A central portion of the traverse felt 22 is projected so that the entire recording surface of a disk to be inserted does not come into contact with the traverse felt 22, and the traverse felt 22 is made of felt material. When a disk can not sufficiently be supported by the first disk guide 17 or second disk guide 81, the front guider 21 and the traverse felt 22 can prevent the recording surface from being damaged by inclination toward the surface of the disk. The front guider 21 may be made of felt material, and the traverse felt 22 may be coated with urethane fluorine.

Next, the detecting motion of the disk will be explained using FIGS. 2 and 3.

FIG. 2 shows a state where no disk is inserted. That is, the guide 112 of the limiting lever 110 is located on a front side, and the operation pin 114 of the limiting lever 110 is located closer to a rear surface than the printed board 13. If a disk is inserted to a predetermined position, the operation pin 114 moves in a longitudinal direction of the printed board 14, and operates the switch lever 116 of the disk insertion detecting switch 115, thereby detecting the insertion of the disk. A moving range of the operation pin 114 is closer to the rear surface than the turning fulcrum 111 of the limiting lever 110, and the operation pin 114 is located on the limiting lever 110 such that the moving range is substantially in parallel to the rear surface of the base body 10. The disk insertion detecting switch 115 is provided such that the switch lever 116 is disposed close to the rear surface of the base body 10 By disposing the switch lever 116 close to the rear surface in this manner, the operation pin 114 can be brought close to the rear surface.

Next, another embodiment will be explained using FIGS. 4 and 5.

In this embodiment, the printed board 14 is close to the rear surface of the base body 10. In the printed board 14, a motion hole 14A is provided in a moving range of the operation pin 114 or in a range wider than the moving range. The operation pin 114 is disposed in the motion hole 14A. It is preferable that the operation pin 114 is disposed such that its moving range is substantially in parallel to the rear surface of the base body 10. Therefore, the motion hole 14A is also provided in the printed board 14 such that it is substantially in parallel to the rear surface of the base body 10. The disk insertion detecting switch 115 is provided such that the switch lever 116 is disposed close to the rear surface of the base body 10.

In this embodiment, in a state where no disk is inserted, the operation pin 114 pushes the switch lever 116 of the disk insertion detecting switch 115, and if the limiting lever 110 is operated, the switch lever 116 of the disk insertion detecting switch 115 is opened.

According to this embodiment, the printed board 14 can be disposed close to the rear surface of the base body 10, and the motion hole 14A provided in the printed board 14 is directed in the longitudinal direction of the printed board 14. Therefore, constraints of wiring on the printed board 14 can be reduced.

### INDUSTRIAL APPLICABILITY

The disk apparatus of the embodiment is especially effective as a disk apparatus which is incorporated in a so-called notebook personal computer in which display means, input means, processing means and the like are integrally provided.

1. A disk apparatus comprising a chassis outer sheath having a base body and a lid, in which a front surface of said chassis outer sheath is formed with a disk inserting opening into which a disk is directly inserted, a connector is disposed on a rear surface of said chassis outer sheath, a traverse is disposed on a side of said disk inserting opening, a printed board is disposed on a side of said connector, said traverse holds a spindle motor, a pickup and drive means which drives said pickup, said spindle motor is disposed on a central portion of said base body, a lever which is moved by inserting a disk is provided on the side of the rear surface of said base body, a rear base is provided at a location which is not superposed with said traverse and at a location covering said printed board, an operation pin is provided on a lower surface of said lever, a disk insertion detecting switch is disposed in the vicinity of a rear portion on said printed board, wherein the moving range of said operation pin is located closer to the rear surface than a turning fulcrum of said lever.

2. The disk apparatus according to claim 1, wherein the moving range of said operation pin is a rear surface side end of said printed board.

3. The disk apparatus according to claim 1, wherein said operation pin is disposed such that the moving range of said operation pin is substantially in parallel to said rear surface.

4. The disk apparatus according to claim 2, wherein a motion hole of said operation pin is provided in a moving range of said operation pin on said printed board or a range wider than the moving range.

5. The disk apparatus according to claim 1, wherein said disk insertion detecting switch is provided such that a switch lever is disposed close to the rear surface.

6. The disk apparatus according to claim 3, wherein a motion hole of said operation pin is provided in a moving range of said operation pin on said printed board or a range wider than the moving range.
